(19) United States
(12) Patent Application Publication
(10) Pub. No.: US 2024/0316884 A1
(43) Pub. Date: Sep. 26, 2024

(54) POLYMERIC COMPONENTS WITH REDUCED FRICTION SURFACES AND METHODS OF MANUFACTURING THE SAME

(71) Applicant: Aisin Corporation, Kariya Aichi (JP)

(72) Inventors: Saida Khan, Canton, MI (US); Narita Masahiro, Novi, MI (US); Kaname Matsuyama, Novi, MI (US)

(21) Appl. No.: 18/125,433

(22) Filed: Mar. 23, 2023

(51) Int. Cl. B29C 71/00; B29C 45/00; B29C 45/26

(52) U.S. Cl. CPC B29C 71/0072; B29C 45/0001; B29C 45/26; B29K 2023/12; B29K 2105/162; B29K 2507/04; B29K 2509/00; B29K 2995/0008

(57) ABSTRACT

A component includes an injection molded polymeric layer with a surface magnetically enriched with a magnetic graphene-based nanocomposite. Also, a method of manufacturing the component includes injecting a polymer-magnetic graphene composite into a mold cavity to form the component, the polymer-magnetic graphene composite including a polymer and the magnetic graphene-based nanocomposite, and applying a magnetic field to at least a portion of the mold cavity containing the polymer-magnetic graphene composite such that the magnetic graphene-based nanocomposite migrates to and enriches a surface of the component.

### TECHNICAL FIELD

The present disclosure relates generally to polymeric components and, more particularly, to polymeric components with reduced friction surfaces.

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly nor impliedly admitted as prior art against the present technology.

Polymeric components are often used or employed in devices or machines that have one or more moving parts such that the polymeric components have surfaces that are subject to wear. For example, polymeric components such as seals, wipers, rails, and tracks, among others, typically have one or more surfaces that are in, or come into, sliding contact with one or adjacent components.

The present disclosure addresses issues related to wear of polymeric components, and other issues related to manufacturing polymeric components.

### SUMMARY

This section provides a general summary of the disclosure and is not a comprehensive disclosure of its full scope or all its features.

In one form of the present disclosure, a component includes an injection molded polymeric layer with a surface of the injected molded polymeric layer magnetically enriched with a magnetic graphene-based nanocomposite.

In another form of the present disclosure, a method of manufacturing a component includes injecting a polymer-magnetic graphene composite into a mold cavity to form the component and applying a magnetic field to at least a portion of the mold cavity containing the polymer-magnetic graphene composite such that a magnetic graphene-based nanocomposite migrates to and enriches a surface of the component.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1A is a side cross-sectional view of a polymeric component with a reduced friction surface according to the teachings of the present disclosure;

FIG. 1B is a graphical plot of weight percent (wt. %) graphene as a function of distance from the reduced friction surface in FIG. 1A;

FIG. 2 is a side cross-sectional side view of an injection molding machine manufacturing a polymeric component with a reduced friction surface according to the teachings of the present disclosure;

FIG. 3 is a cut-away view of another injection molding machine manufacturing a polymeric component with a reduced friction surface according to the teachings of the present disclosure;

FIG. 4A is a cross-sectional view of a core of a polymeric component being formed in a first mold set according to the teachings of the present disclosure;

FIG. 4B is a cross-sectional view of the core in FIG. 4A positioned in a second mold set according to the teachings of the present disclosure;

FIG. 4C is a cross-sectional view of an overmolded outer layer with a reduced friction surface being formed on the core in the second mold set according to the teachings of the present disclosure;

FIG. 5 is a cross-sectional view of a polymeric component with a reduced friction surface being formed with a two-shot injection molding process according to the teachings of the present disclosure;

FIG. 5A is one example of the polymeric component in FIG. 5 with a graphene-enriched friction reduced surface;

FIG. 5B is another example of the polymeric component in FIG. 5 with a graphene-enriched friction reduced surface;

FIG. 5C is still another example of the polymeric component in FIG. 5 with two graphene-enriched friction reduced surfaces;

FIG. 6 is a side cross-sectional side view of a still another injection molding machine manufacturing a polymeric component with a reduced friction surface according to the teachings of the present disclosure; and

FIG. 7 is a flow chart for a method of making a polymeric component with a reduced friction surface according to the teachings of the present disclosure.

It should be noted that the figures set forth herein are intended to exemplify the general characteristics of the methods, devices, and systems among those of the present technology, for the purpose of the description of certain aspects. The figures may not precisely reflect the characteristics of any given aspect and are not necessarily intended to define or limit specific forms or variations within the scope of this technology.

### DETAILED DESCRIPTION

The present disclosure provides a polymeric component and a method for making a polymeric component that has a graphene-enriched reduced friction surface. As used herein, the phrase “graphene-enriched reduced friction surface” refers to a surface of polymeric component that is enriched with graphene compared to an inner or interior portion of the polymeric component where the graphene-enriched reduced friction surface is located or present. In addition, the graphene-enriched reduced friction surface has a coefficient of friction that is less than a coefficient of friction for a surface of the polymeric component that is not enriched with graphene.

In some variations of the present disclosure, the graphene-enriched reduced friction surface is magnetically enriched during injection molding of the polymeric component. As used herein, the phrase “magnetically enriched” refers to enriching a surface of a polymeric component with graphene by applying a magnetic field (e.g., an AC magnetic field or a DC magnetic field) across a layer or portion of the polymeric component during injection molding thereof such that a magnetic graphene-based nanocomposite migrates towards the surface. And as used herein, the term “magnetic” refers to a material, e.g., a nanoparticle and/or graphene containing particle, that is actuated or actuatable with an applied magnetic field.

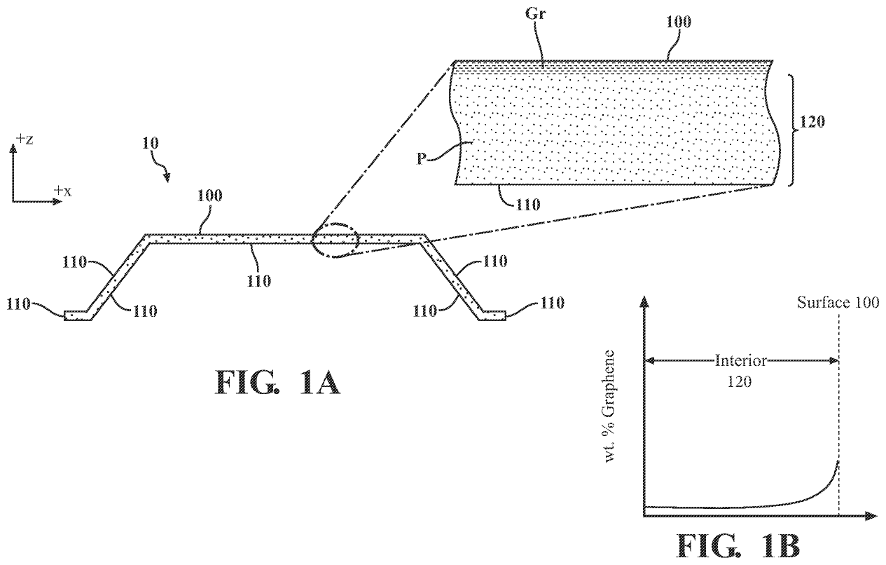

Referring to FIG. 1A, a polymeric component 10 with a graphene-enriched reduced friction surface 100 is shown. The polymeric component 10 is formed from a polymeric material ‘P’ and has a desired shape, e.g., the shape of an injection mold cavity, and the graphene-enriched reduced friction surface 100 has a concentration of graphene ‘Gr” that is greater than a concentration of graphene at other locations of the polymeric component 10. For example, the polymeric component 10 can include one or more surfaces 110 that are not graphene-enriched and accordingly, are not reduced friction surfaces. In addition, an interior 120, i.e., an inner region within the polymeric component 10 that may or may not be adjacent to the graphene-enriched reduced friction surface 100 has a concentration of graphene that is less than the concentration of graphene at the graphene-enriched reduced friction surface 100. Accordingly, the polymeric component 10 has a gradient (increasing gradient) of graphene from the interior 120 to the graphene-enriched reduced friction surface 100 as illustrated in FIG. 1B.

The graphene-enriched reduced friction surface 100 is well suited and/or designed as a sliding surface for the polymeric component 10. That is, the reduced coefficient of friction exhibited by the graphene-enriched reduced friction surface 100 reduces wear between the graphene-enriched reduced friction surface 100 and another component (not shown) that is in sliding and/or vibrational contact with the graphene-enriched reduced friction surface 100.

In some variations, the polymeric material P is at least one of a thermoplastic, a thermoset epoxy, and a phenolic polymer. For example, in some variations the polymeric material P is at least one of polypropylene (PP), polybutylene terephthalate (PBT), acrylonitrile butadiene styrene (ABS), and combinations thereof, among others. And in at least one variation of the present disclosure, the polymeric material P is polypropylene. Also, in some variations, the polymeric material P is a polymeric composite material, e.g., a polymer-glass fiber composite material and/or polymer-carbon fiber composite material, among others.

In some variations, the graphene Gr is present or in the form of a magnetic graphene-based (M-Gr) nanocomposite particles (e.g., graphene decorated with magnetic nanoparticles such as magnetic metal nanoparticles and/or magnetic metal oxide nanoparticles, among others). Non-limiting examples of M-Gr nanocomposites including Ti-Gr nanocomposites, Cr-Gr nanocomposites, Mn-Gr nanocomposites, Fe-Gr nanocomposites, iron oxide nanocomposites such as Fc/Fc₂O₃-Gr nanocomposites, γ-Fc₂O₃-Gr nanocomposites, Fe/Fe₃O₄-Gr nanocomposites, and Fe₃O₄-Gr nanocomposites, Ni-Gr nanocomposites, Co-Gr nanocomposites, Co₃O₄-Gr nanocomposites, and combinations thereof, as disclosed in the reference titled “Magnetic-Graphene-Based Nanocomposites and Respective Applications” by Kharissova et al., (http://dx.doi.org/10.5772/64319) which is incorporated herein in its entirety by reference. In at least one variation, the M-Gr nanocomposite includes metal core-metal oxide shell nanoparticles (i.e., core-shell nanoparticles), e.g., Fe core-Fe₃O₄ shell nanoparticles, among others.

As noted above, the graphene-enriched reduced friction surface 100 has a reduced coefficient of friction for enhanced sliding and reduced wear. In some variations, the graphene-enriched reduced friction surface 100, and other graphene-enriched reduced friction surfaces disclosed herein, have a coefficient of friction that is between about 10% and about 75% of a coefficient of friction for the one or more surfaces 110 that are not graphene-enriched. For example, in some variations the coefficient of friction for the one or more surfaces 110 is about 0.6 and the coefficient of friction for the graphene-enriched reduced friction surface 100 is less than about 0.4, e.g., between about 0.4 to about 0.1. In other variations, the coefficient of friction for the one or more surfaces 110 is about 0.5 and the coefficient of friction for the graphene-enriched reduced friction surface 100 is less than about 0.4, e.g., between about 0.4 to about 0.1. In at least one variation, the coefficient of friction for the one or more surfaces 110 is about 0.4 and the coefficient of friction for the graphene-enriched reduced friction surface 100 is less than about 0.3, e.g., between about 0.3 to about 0.1. In still other variations, the coefficient of friction for the one or more surfaces 110 is about 0.3 and the coefficient of friction for the graphene-enriched reduced friction surface 100 is less than about 0.2, e.g., between about 0.2 to about 0.05. And in still let other variations, the coefficient of friction for the one or more surfaces 110 is about 0.2 and the coefficient of friction for the graphene-enriched reduced friction surface 100 is less than about 0.1, e.g., between about 0.1 to about 0.01.

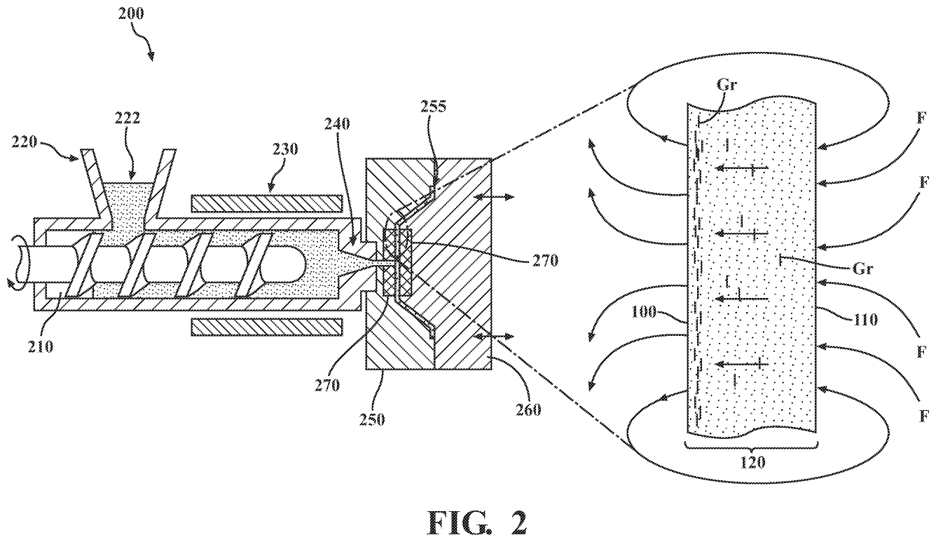

Referring now to FIG. 2, one example of forming the polymeric component 10 with the graphene-enriched reduced friction surface 100 is shown. Particularly, the polymeric component 10 being formed with an injection molding machine 200 is shown. The injection molding machine 200 includes an injection ram 210, a hopper 220, a heating device 230, a nozzle 240, and a mold cavity 255 between a first mold die 250 and a second mold die 260. The hopper 220 contains a polymer-magnetic graphene composite 222 that is heated and extruded into the mold cavity 255 such that the polymeric component 10 has the shape of the mold cavity 255.

In some variations, the polymer-magnetic graphene composite 222 includes a mixture of the polymeric material P and M-Gr nanocomposite particles (labeled as ‘Gr’ in FIG. 2). In addition, the injection molding machine 200 includes one or more electromagnetic coils 270 that create a magnetic flux ‘F’ through at least a portion of the polymeric component 10 as it is being formed. The magnetic flux F applies a magnetic force on the M-Gr nanocomposite particles Gr such that the M-Gr nanocomposite particles Gr migrate towards and enrich a predefined surface (e.g., the graphene-enriched reduced friction surface 100) of the polymeric component 10 with graphene before the polymeric material P solidifies.

In some variations, the polymer-magnetic graphene composite 222 is in the form of pellets. For example, in some variations the polymer-magnetic graphene composite 222 includes a portion of pellets formed from just the polymeric material P and a portion of pellets formed from a mixture of the polymeric material P and M-Gr nanocomposite particles Gr. While in other variations, all of the pellets of the polymer-magnetic graphene composite 222 are a mixture of the polymeric material P and the M-Gr nanocomposite particles Gr. i.e., pellets of the polymeric material P with the M-Gr nanocomposite particles Gr dispersed therein.

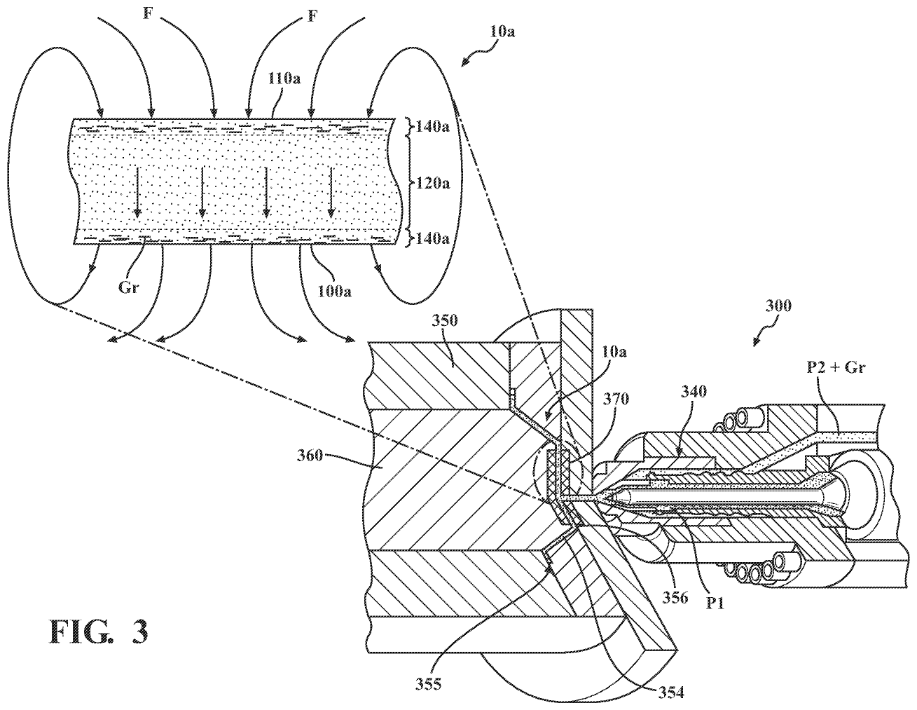

Referring to FIG. 3, another example of forming a polymeric component 10a with a graphene-enriched reduced friction surface 100a according to the teachings of the present disclosure is shown. Particularly, the polymeric component 10a being formed with an injection molding machine 300 is shown. The injection molding machine 300 includes an injection ram (not shown), at least two hoppers (not shown), a heating device (not shown), a nozzle 340, and a mold cavity 355 between a first mold die 350 and a second mold die 360. The nozzle 340 is configured to inject a polymeric material P1 into an inner portion of region 354 of the mold cavity 355 to form an inner portion 120a of the polymeric component 10a and inject another polymeric material P2 into an outer region 356 of the mold cavity 355 to form an outer portion 140a of the polymeric component 10a as illustrated in FIG. 3.

In some variations, the first polymeric material P1 does not contain graphene and the second polymeric material P2 is a mixture of the second polymeric material P2 and M-Gr nanocomposite particles Gr (labeled P2+Gr in FIG. 3). And in such variations, the injection molding machine 300 can include one or more electromagnetic coils 370 that create a magnetic flux ‘F’ through at least a portion of the polymeric component 10a as it is being formed. The magnetic flux F applies a magnetic force on the M-Gr nanocomposite particles Gr such that the M-Gr nanocomposite particles Gr migrate towards and enrich a predefined surface (e.g., a graphene-enriched reduced friction surface 100a) of the polymeric component 10a before the second polymeric material P2 solidifies. It should be understood that the first polymeric material P1 and the second polymeric material P2 may or may not be the same polymeric material. That is, in some variations the second polymeric material P2 is a different polymer than the first polymeric material P1, while in other variations, the second polymeric material P2 is the same polymer than the first polymeric material P1.

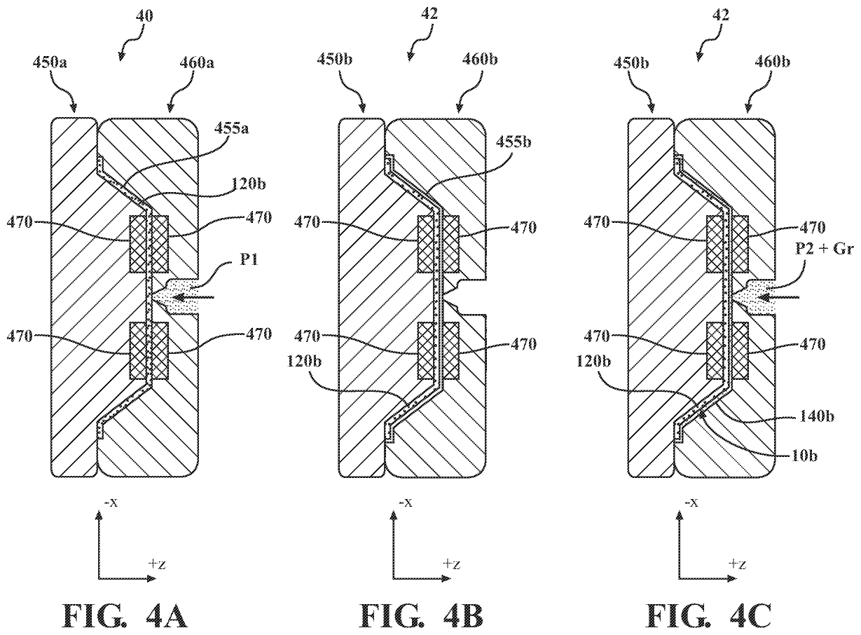

Referring to FIGS. 4A-4C, forming a polymeric component 10b with a graphene-enriched reduced friction surface using an overmolding process according to another form of the present disclosure is shown. In some variations, and with reference to FIG. 4A, a core layer 120b is formed by injecting a first polymeric material P1 into a mold cavity 455a defined between a first mold die 450a and a second mold die 460a of a first mold set 40a. The core layer 120b is removed from the mold cavity 455a and placed within another mold cavity 455b defined between another first mold die 450b and another second mold die 460b of a second mold set 40b as shown in FIG. 4B, and a second polymeric material P2 with M-Gr nanocomposite particles Gr (labeled P2+Gr in FIG. 4C) is injected molded into the mold cavity 455b to form an overmolded layer 140b as shown in FIG. 4C. In the alternative, the core layer 120b is formed by injecting the second polymeric material P2 with M-Gr nanocomposite particles Gr into the mold cavity 455a (not shown) defined between a first mold die 450a and a second mold die 460a of a first mold set 40a. The core layer 120b is removed from the mold cavity 455a and placed within the mold cavity 455b (not shown) defined between the first mold die 450b and the second mold die 460b of the second mold set 40b as shown in FIG. 4B, and the polymeric material P1 is injected molded into the mold cavity 455b to form the overmolded layer 140b as shown in FIG. 4C.

In some variations the first mold die 450a is the same mold die as the first mold die 450b, while in other variations the first mold die 450a is a different mold die than the first mold die 450b. In addition, the first mold die 450a and the second mold die 460a, and/or the first mold die 450b and the second mold die 460b include one or more electromagnetic coils 470 that create a magnetic flux F (not shown) through at least a portion of the polymeric component 10b as it is being formed. The magnetic flux F applies a magnetic force on the M-Gr nanocomposite particles Gr such that the M-Gr nanocomposite particles Gr migrate towards a predefined surface of the polymeric component 10b before the polymer P1 or P2 solidifies, and thereby enriches the predefined surface with graphene.

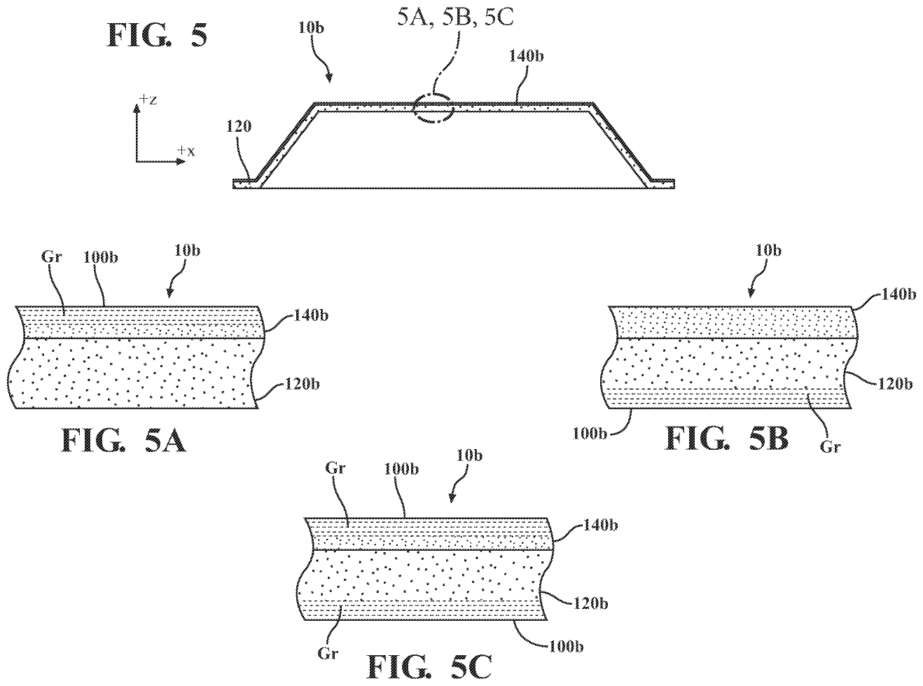

Referring to FIGS. 5-5C, a cross-sectional view of the polymeric component 10b is shown in FIG. 5 and three examples of the polymeric component 10b having a graphene-enriched friction reduced surface 100b are shown in FIGS. 5A-5C. With reference to FIG. 5A (and as illustrated in FIGS. 4A-4C), in some variations the first polymeric material P1 is injected into the mold cavity 455a defined between the first mold die 450a and the second mold die 460a of a first mold set 40a, and the second polymeric material P2 with M-Gr nanocomposite particles Gr is injected into the mold cavity 455b between the first mold die 450a and the second mold die 460a of a first mold set 40a. And in such variations, one or more of the electromagnetic coils 470 disposed within the first mold die 450b and the second mold die 460b are activated during and/or after injection molding of the second polymeric material P2 with M-Gr nanocomposite particles Gr into the mold cavity 455b such that the magnetic flux F (not shown) passes through at least a portion of the overmolded layer 140b as it is being formed. The magnetic flux F applies a magnetic force on the M-Gr nanocomposite particles Gr such that the M-Gr nanocomposite particles Gr migrate towards and enrich a predefined surface (e.g., a graphene-enriched reduced friction surface 100b) of the overmolded layer 140b with graphene before the polymer P2 solidifies. Accordingly, the overmolded layer 140b includes the graphene-enriched reduced friction surface 100b as shown in FIG. 5A.

With reference to FIG. 5B, in some variations the second polymeric material P2 with M-Gr nanocomposite particles Gr is injected into the mold cavity 455a (not shown) defined between the first mold die 450a and the second mold die 460a of a first mold set 40a, and the first polymeric material P1 is injected into the mold cavity 455b (not shown) between the first mold die 450a and the second mold die 460a of a first mold set 40a. And in such variations, one or more of the electromagnetic coils 470 disposed within the first mold die 450a and the second mold die 460a (FIG. 4A) are activated during and/or after injection molding of the second polymeric material P2 with M-Gr nanocomposite particles Gr into the mold cavity 455a such that a magnetic flux F passes through at least a portion of the core layer 120b as it is being formed. The magnetic flux F applies a magnetic force on the M-Gr nanocomposite particles Gr such that the M-Gr nanocomposite particles Gr migrate towards and enrich a predefined surface (e.g., a graphene-enriched reduced friction surface 100b) of the core layer 120b with graphene before the polymer P2 solidifies. Accordingly, the core layer 120b includes the graphene-enriched reduced friction surface 100b as shown in FIG. 5B.

And with reference to FIG. 5C, in some variations the second polymeric material P2 with M-Gr nanocomposite particles Gr is injected into the mold cavity 455a (not shown) defined between the first mold die 450a and the second mold die 460a of a first mold set 40a, and the second polymeric material P2 with M-Gr nanocomposite particles Gr is injected into the mold cavity 455b between the first mold die 450a and the second mold die 460a of a first mold set 40a (FIG. 4C). And in such variations, one or more of the electromagnetic coils 470 disposed within the first mold die 450a and the second mold die 460a (FIG. 4A) are activated during and/or after injection molding of the second polymeric material P2 with M-Gr nanocomposite particles Gr into the mold cavity 455a such that a magnetic flux F passes through at least a portion of the core layer 120b as it is being formed. The magnetic flux F applies a magnetic force on the M-Gr nanocomposite particles Gr such that the M-Gr nanocomposite particles Gr migrate towards and enrich a predefined surface (e.g., a graphene-enriched reduced friction surface 100b) of the core layer 120b before the polymer P2 solidifies as shown in FIG. 5C.

In addition, one or more of the electromagnetic coils 470 disposed within the first mold die 450b and the second mold die 460b are activated during and/or after injection molding of the second polymeric material P2 with M-Gr nanocomposite particles Gr into the mold cavity 455b such that a magnetic flux F passes through at least a portion of the overmolded layer 140b as it is being formed. The magnetic flux F applies a magnetic force on the M-Gr nanocomposite particles Gr such that the M-Gr nanocomposite particles Gr migrate towards and enrich a predefined surface (e.g., another graphene-enriched reduced friction surface 100b) of the overmolded layer 140b with graphene before the polymer P2 solidifies. Accordingly, the overmolded layer 140b also includes a graphene-enriched reduced friction surface 100b such that the core layer 120b and the overmolded layer 140b each include a graphene-enriched reduced friction surface 100b.

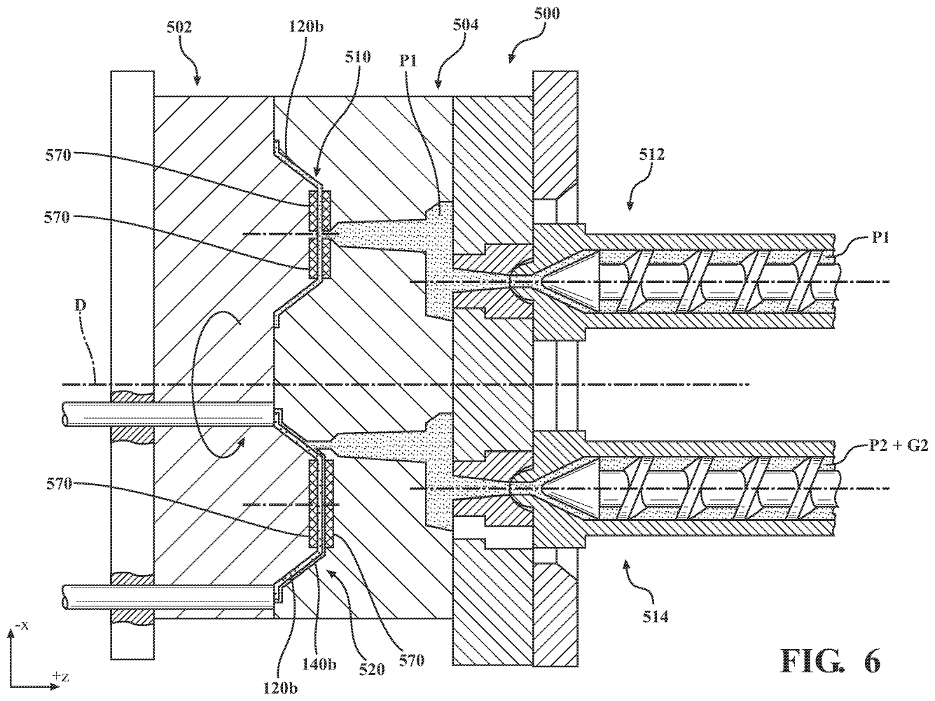

Referring to FIG. 6, forming the polymeric component 10b using a two-shot injection molding process or machine 500 according to another form of the present disclosure is shown. The two-shot injection molding machine 500 includes a rotatable first mold die 502, a second mold die 504 with a first mold cavity 510 and a second mold cavity 520, a first injection unit 512, and a second injection unit 514. The first injection unit 512 injects the first polymeric material P1 or the second polymeric material P2 with M-Gr nanocomposite particles Gr into the first mold cavity 510 (only first polymeric material P1 shown in FIG. 6) and forms the core layer 120b. Then the rotatable first mold die 502 with the core layer 120b rotates about a die axis ‘D’ such that the core layer 120b is positioned within the second mold cavity 520. The second injection unit 514 injects the second polymeric material P2 with M-Gr nanocomposite particles Gr (labeled P2+Gr in FIG. 6) or the first polymer material P1 into the second mold cavity 520 (only P2+G2 shown) and forms the overmolded layer 140b onto the core layer 120b. Also, the first injection unit 512 injects the first polymeric material P1 into the first mold cavity 510 and forms another core layer 120b.

After the two-shot injection molded overmolded layer 140b is formed, the rotatable first mold die 502 and the second mold die 504 are separated from each other (x-direction), the polymeric component 10b is pushed (removed) off of the rotatable first mold die 502, and the rotatable first mold die 502 rotates about the die axis D such that the another core layer 120b is positioned within the second mold cavity 520. This cycle, i.e., forming of a core layer 120b in the first mold cavity 510, forming of the overmolded layer 140b onto a core layer 120b in the second mold cavity 520, removing the polymeric component 10b from the rotatable first mold die 502, and rotating the rotatable first mold die 502, continues such that a plurality of polymeric components 10b are formed.

In some variations, the rotatable first mold die 502 and the second mold die 504 include one or more electromagnetic coils 570 adjacent the second mold cavity 520. In other variations, the rotatable first mold die 502 and the second mold die 504 include one or more electromagnetic coils 570 adjacent the first mold cavity 510. And in at least one variation, the rotatable first mold die 502 and the second mold die 504 include one or more electromagnetic coils 570 adjacent the first mold cavity 510 and one or more electromagnetic coils 570 adjacent the second mold cavity 520.

In variations where the rotatable first mold die 502 and the second mold die 504 include one or more electromagnetic coils 570 adjacent the second mold cavity 520, the first polymeric material P1 is injected into the first mold cavity 510 to form the core layer 120b, and the second polymeric material P2 with M-Gr nanocomposite particles Gr is injected into the second mold cavity 520 to form the overmolded layer 140b. Also, the one or more of the electromagnetic coils 470 are activated during and/or after injection molding of the second polymeric material P2 with M-Gr nanocomposite particles Gr into the second mold cavity 520 such that a magnetic flux F passes through at least a portion of the overmolded layer 140b as it is being formed. The magnetic flux F applies a magnetic force on the M-Gr nanocomposite particles Gr such that the M-Gr nanocomposite particles Gr migrate towards and enrich a predefined surface (e.g., a graphene-enriched reduced friction surface 100b as shown in FIG. 5A) of the overmolded layer 140b with graphene before the polymer P2 solidifies. Accordingly, the overmolded layer 140b includes the graphene-enriched reduced friction surface 100b as illustrated in FIG. 5A.

In variations where the rotatable first mold die 502 and the second mold die 504 include one or more electromagnetic coils 570 adjacent the first mold cavity 510, the second polymeric material P2 with M-Gr nanocomposite particles Gr is injected into the first mold cavity 510 to form the core layer 120b, and the one or more of the electromagnetic coils 470 are activated during and/or after injection molding of the second polymeric material P2 with M-Gr nanocomposite particles Gr into the first mold cavity 510 such that a magnetic flux F passes through at least a portion of the core layer 120b as it is being formed. The magnetic flux F applies a magnetic force on the M-Gr nanocomposite particles Gr such that the M-Gr nanocomposite particles Gr migrate towards and enrich a predefined surface (e.g., a graphene-enriched reduced friction surface 100b as shown in FIG. 5B) of the core layer 120b with graphene before the polymer P2 solidifies. Then, the first polymeric material P1 is injected into the second mold cavity 520 to form the overmolded layer 140b. Accordingly, the core layer 120b includes the graphene-enriched reduced friction surface 100b as illustrated in FIG. 5B.

And in variations where the rotatable first mold die 502 and the second mold die 504 include one or more electromagnetic coils 570 adjacent the first mold cavity 510, and one or more electromagnetic coils 570 adjacent the second mold cavity 520, the second polymeric material P2 with M-Gr nanocomposite particles Gr is injected into the first mold cavity 510 to form the core layer 120b, and the one or more of the electromagnetic coils 470 are activated during and/or after injection molding of the second polymeric material P2 with M-Gr nanocomposite particles Gr into the first mold cavity 510 such that a magnetic flux F passes through at least a portion of the core layer 120b as it is being formed. Then, the second polymeric material P2 with M-Gr nanocomposite particles Gr is injected into the second mold cavity 520 to form the overmolded layer 140b, and the one or more of the electromagnetic coils 470 are activated during and/or after injection molding of the second polymeric material P2 with M-Gr nanocomposite particles Gr into the second mold cavity 520 such that a magnetic flux F passes through at least a portion of the overmolded layer 140b as it is being formed. Accordingly, the core layer 120b and the overmolded layer 140b include a graphene-enriched reduced friction surface 100b as illustrated in FIG. 5C.

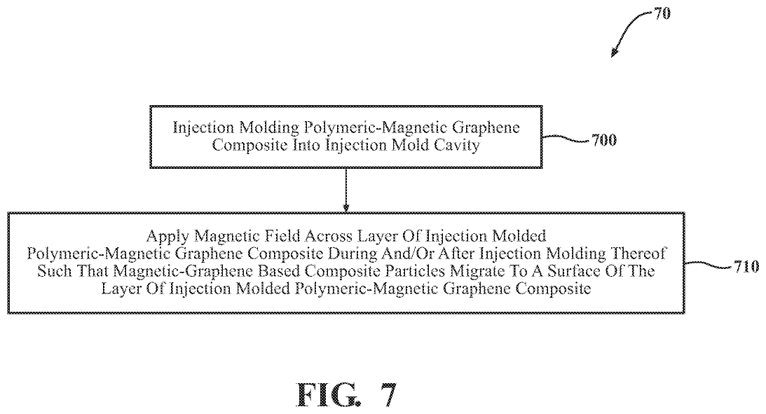

Referring now to FIG. 7, a method 70 for forming a polymeric component with a graphene-enriched reduced friction surface includes injection molding a polymer-magnetic graphene composite into an injection mold cavity at 700 and applying a magnetic field across a layer of the injection molded component during and/or after injection molding thereof such that magnetic graphene-based based composite particles migrate to a desired surface at 710 of polymeric component. In some variations the polymeric component is a single layer polymeric component as illustratively discussed above with respect to FIGS. 1A-2, while in other variations the polymeric component is a multiple layer polymeric component as illustratively discussed above with respect to FIGS. 3-6. Also, in some variations the applied magnetic field is an AC magnetic field, while in other variations the applied magnetic field is a DC magnetic field.

The preceding description is merely illustrative in nature and is in no way intended to limit the disclosure, its application, or uses. As used herein, the phrase at least one of A. B. and C should be construed to mean a logical (A or B or C), using a non-exclusive logical “or.” The various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple embodiments having stated features is not intended to exclude other embodiments having additional features, or other embodiments incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise,” “include,” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms. Therefore, while this disclosure includes examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of an embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A component comprising:
an injection molded polymeric layer; and
a surface of the injected molded polymeric layer magnetically enriched with a magnetic graphene-based nanocomposite.

2. The component according to claim 1, wherein the injection molded polymeric layer is formed from at least one of a thermoplastic, a thermoset epoxy, and a phenolic polymer.

3. The component according to claim 1, wherein the injection molded polymeric layer is formed from at least one of polypropylene, polybutylene terephthalate, and acrylonitrile butadiene styrene layer.

4. The component according to claim 1, wherein the injection molded polymeric layer is formed from polypropylene.

5. The component according to claim 1, wherein the surface has a coefficient of friction less than 0.3.

6. The component according to claim 5, wherein the coefficient of friction is less than 0.2.

7. The component according to claim 6, wherein the coefficient of friction is less than 0.1.

8. The component according to claim 1, wherein the magnetic graphene-based nanocomposite comprises magnetic oxide nanoparticles.

9. The component according to claim 8, wherein the magnetic oxide nanoparticles comprise iron oxide nanoparticles.

10. The component according to claim 9, wherein the iron oxide nanoparticles comprise Fe₃O₄.

11. The component according to claim 9, wherein the iron oxide nanoparticles are core-shell nanoparticles comprising an Fe core and an Fe₃O₄ shell.

12. A method of manufacturing a component, the method comprising:
injecting a polymer-magnetic graphene composite into a mold cavity to form the component, the polymer-magnetic graphene composite comprising a polymer and a magnetic graphene-based nanocomposite; and
applying a magnetic field to at least a portion of the mold cavity containing the polymer-magnetic graphene composite such that the magnetic graphene-based nanocomposite migrates to and enriches a surface of the component.

13. The method according to claim 12, wherein the polymer is at least one of a thermoplastic, a thermoset epoxy, and a phenolic polymer.

14. The method according to claim 12, wherein the polymer is at least one of polypropylene, polybutylene terephthalate, and acrylonitrile butadiene styrene layer.

15. The method according to claim 12, wherein the polymer is polypropylene.

16. The method according to claim 12, wherein the surface has a coefficient of friction less than 0.3.

17. The method according to claim 16, wherein the coefficient of friction is less than 0.2.

18. The method according to claim 17, wherein the coefficient of friction is less than 0.1.

19. The method according to claim 12, wherein the magnetic graphene-based nanocomposite comprises magnetic oxide nanoparticles.

20. The method according to claim 19, wherein the magnetic oxide nanoparticles comprise iron oxide nanoparticles.
